(19) United States
(12) Patent Application Publication
(10) Pub. No.: US 2009/0091791 A1
(43) Pub. Date: Apr. 9, 2009

(54) METHODS AND SYSTEMS FOR THIRD-PARTY ADMINISTRATIVE CONTROL OF REMOTE IMAGING JOBS AND IMAGING DEVICES

(76) Inventor: Andrew Rodney Ferlitsch, Camas, WA (US)

Correspondence Address: Duft Bornsen & Fishman, LLP, 1526 Spruce Street, Suite 302, Boulder, CO, 80302, US

(21) Appl. No.: 12/325,237

(22) Filed: Nov. 30, 2008

Related U.S. Application Data
(63) Continuation-in-part of application No. 11/536,115, filed on Sep. 28, 2006.

(51) Int. Cl. G06F 3/12

(52) U.S. Cl. 358/1.15

(57) ABSTRACT

Embodiments of the present invention comprise systems and methods for third-party administrative control of remote imaging jobs and imaging devices. In some embodiments, administrative controls may be used in conjunction with the remote user interface features to restrict access to the imaging device by remote user devices, remote user interface applications, and/or walkup users. In other embodiments, a server may provide a discovery process for imaging devices coupled thereto and may maintain a central repository for device capabilities information. The server may further emulate remote user interface capabilities for those imaging devices that do not directly support such features. In still other embodiments, a monitor process may be spawned to monitor status of the imaging device and jobs thereon and to control the state of job processing on the imaging device.

### RELATED PATENT APPLICATIONS

The present application claims priority as a continuation in part to commonly owned, co-pending, U.S. patent application Ser. No. 11/536,115 filed 28 Sep. 2006 and entitled METHODS AND SYSTEMS FOR THIRD-PARTY CONTROL OF REMOTE IMAGING JOBS (referred to herein as the “parent” patent application).

### FIELD OF THE INVENTION

Embodiments of the present invention comprise methods and systems for third-party control of remote imaging jobs performed on a peripheral device and more specifically relates to provision of various management services relating to imaging devices using such third-party control features.

### BACKGROUND

Some multi-function peripheral (MFP) devices allow external applications to interact with the on-board functionality of the device. However, these devices limit user interaction to input from the MFP hardware user interface (UI) on the device. These devices do not allow control to be extended to imaging jobs that originate at a remote source (i.e., non-walkup), such as a PC-print or PC-fax.

The parent patent application discloses and claims various embodiments wherein a remote user device (RUD) may interact with an imaging device (IDev) to provide a remote user interface capability such that a user of the RUD (remote with respect to the IDev) may be presented with a user interface (UI) defined by the IDev while interacting with the RUD.

Other administrative functions relating to the configuration and/or operation of the IDev, remote with respect to the RUD, may still require physical user interaction with the IDev (e.g., proximate the IDev's user interface).

It is evident from the above discussion that a need exists for improved methods and systems for effective administration procedures relating to an imaging device utilizing a remote user device.

### SUMMARY

The present invention provides still further features and benefits based on the remote user interface capabilities first disclosed in the parent patent application.

In some embodiments, a method is provided for performing administrative controls on an imaging device. The method includes establishing a bi-directional communication link between an imaging device (IDev) and a remote user device (RUD) and establishing a remote user interface over the bi-directional communication link. The remote user interface is used by a user of the IDev to control a remote application operable on the RUD and/or is used by a user of the RUD to control the IDev. The method further includes directing the IDev to restrict access to the IDev responsive to the establishment of the remote user interface.

Other embodiments provide a method for performing administrative controls on an imaging device. The method includes discovering an imaging device (IDev) coupled to a server system and querying the imaging device to determine capability information relating to features supported by the imaging device. The method then saves the capability information in the server. The method further includes retrieving the capability information from the server for use by a remote user device (RUD). The method then establishes a remote user interface based on the retrieved capability information. The remote user interface used by a user of the RUD to control the IDev.

Still other embodiments provide a method for performing administrative controls on an imaging device. The method includes establishing a bi-directional communication link between an imaging device (IDev) and a remote user device (RUD) and establishing a remote user interface over the bi-directional communication link. The remote user interface is used by a user of the IDev to control a remote application operable on the RUD and/or is used by a user of the RUD to control the IDev. The method further includes creating a monitor process on the RUD to monitor status of the IDev and exchanging status information between the monitor process and the IDev using the remote user interface to report status of the IDev to a user of the remote user interface.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a diagram depicting exemplary devices and communication links of exemplary embodiments of the present invention;

FIG. 2 is a diagram showing exemplary communication between an RCD and an IDev;

FIG. 3 is a diagram showing transmission of a UI definition from an RCD to an IDev;

FIG. 4 is a diagram showing exemplary communication between a remote user device and an IDev;

FIG. 5 is a diagram showing a UI registration being transmitted from an RCD to an IDev;

FIG. 6 is a diagram showing an exemplary embodiment comprising a UI definition being transmitted from an RCD to an RUD after transmission of the RCD URI to the RUD;

FIG. 7 is a diagram showing an exemplary embodiment comprising a UI definition being transmitted from an RCD to an RUD after a request from the IDev to the RCD;

FIG. 8 is a diagram showing an exemplary transmission of UI responses;

FIG. 9 is a diagram showing an exemplary transmission of driver actions;

FIG. 10 is a diagram showing an exemplary transmission of input responses to an RCD;

FIG. 11 is a diagram showing an exemplary transmission of driver actions and an imaging job;

FIG. 12 is a diagram showing an exemplary transmission of UI responses and logical pages;

FIG. 13 is a diagram showing an exemplary transmission of device actions from an RCD to and IDev;

FIG. 14 is a diagram showing an exemplary transmission of UI responses and page URI's, and

FIG. 15 is a diagram showing an exemplary transmission of device actions and a page data pull.

FIG. 16 is a flowchart of an exemplary method for controlling access to an IDev using a remote user interface.

FIGS. 17 through 19 are flowcharts of exemplary methods providing more detail of the access restriction features of FIG. 16.

FIG. 20 is a flowchart of an exemplary method for automated discover of new IDevs on a network and for caching and utilization of capability information in establishing a remote user interface for each IDev.

FIG. 21 is a flowchart of an exemplary method for monitoring status of an IDev and/or for controlling execution of jobs on an IDev using a remote user interface.

### DETAILED DESCRIPTION OF EXEMPLARY EMBODIMENTS

Embodiments of the present invention will be best understood by reference to the drawings, wherein like parts are designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods and systems of the present invention is not intended to limit the scope of the invention but it is merely representative of some exemplary embodiments of the invention.

Elements of embodiments of the present invention may be embodied in hardware, firmware, and/or software—or any combination of such embodiments. While exemplary embodiments revealed herein may only describe one of these forms, it is to be understood that one skilled in the art would be able to effectuate these elements in any of these forms while resting within the scope of the present invention.

Some embodiments of the present invention comprise methods and systems for allowing imaging jobs that originate at a remote user device (RUD) to be programmatically controlled from a 3^{rd} party application running on a remote computing device (RCD) wherein the 3^{rd} party application is controlling an imaging device (IDev), such as a multi-function peripheral device (IDev 2). Examples of remote jobs that originate on an RUD comprise: PC-print, PC-fax, PC-file and others.

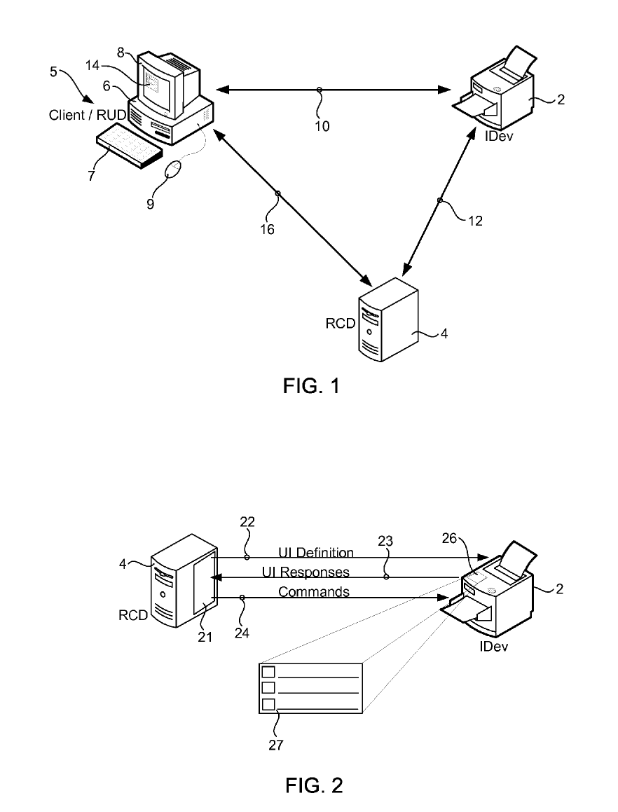

Some embodiments of the present invention may be described with reference to FIG. 1. These embodiments may comprise an imaging device 2 such as a multi-function peripheral device (IDev 2) that may perform multiple imaging functions such as copying, faxing, printing, scanning, filing, publishing, format conversion, displaying, media duplication and other functions. An imaging device may also be a single function device. These embodiments may also comprise a remote computing device (RCD) 4 such as a server, PC, or another computing device. An RCD 4 may comprise a processor, memory, storage devices, communication interfaces, and other elements. The RCD 4 may communicate with other devices through a communication link, such as communication links 12 and 16. In some embodiments, the RCD 4 may only comprise a single communication link, in other embodiments, the RCD 4 may comprise multiple communication links 12, 16. Communication links 12, 16, and 10 may be wired or wireless communication links that employ standard communication protocols for networks, serial communication, parallel communication and other methods that accomplish bi-directional communication.

These embodiments may also comprise a remote user device (RUD) 5, such as a client personal computer (PC), workstation, laptop PC, PDA, smartphone, or another computing device with a user interface (UI) and display. An RUD 5 will typically comprise a central processing unit (CPU) 6, a display 8 and a user interface, such as a keyboard 7 and/or mouse 9. An RUD 5 may also comprise an imaging device driver that runs in conjunction with an operating system on the CPU 6.

In some embodiments data may be transmitted between an RCD 4 and an IDev 2 directly through communication link 12 or indirectly through RUD 5 via communication links 10 and 16. In some embodiments data may be transmitted between an RCD 4 and an RUD 5 directly through communication link 16 or indirectly through IDev 2 via communication links 10 and 12. In some embodiments data may be transmitted from an RUD 5 and an IDev 2 directly through communication link 10 or indirectly through RCD 4 via communication links 12 and 16.

In some embodiments of the present invention, an RCD 4 may take control of an IDev 2 function and allow user control of that function. This may be performed by sending UI content to a UI accessible to a user. In some embodiments, the IDev 2 may receive and display content from the RCD 4 and accept user input in response to the display of that content. In some embodiments, the RCD 4 may send UI content to an RUD 5 for display on the RUD display 8. User input received in response to the display of the UI content 14 on the RUD display 8 may be passed back to the RCD 4, either directly over communication link 16 or through the IDev 2 via communication links 10 and 12.

In some embodiments of the present invention, an exemplary operating environment may comprise an imaging device, such as an IDev 2, whose imaging jobs can be programmatically controlled by an external (3^{rd} party) application running on an RCD 4. In these embodiments, the external controlling application may be registered with the IDev 2. Once registered, the controlling application takes control of the walkup access to the device by taking control of the IDev 2 user interface (UI) (e.g., front panel touch screen UI). In some embodiments, the controlling application may send a UI description to the IDev 2 and the IDev 2 may replace its native UI display with the UI description (e.g., display content) from the controlling application/RCD 4. In other embodiments, the IDev 2 may make a composite UI as a join operation of the UI description sent to it by the RCD 4, and the IDev's 2 native UI. When a walkup user enters input to the IDev UI, which is displaying the controlling application's UI display content, the IDev 2 may send the input responses to the controlling application on the RCD 4. The controlling application on RCD 4 may then interpret the input responses and, when appropriate, send commands back to the IDev 2 to effectuate functions indicated by the user's input.

In embodiments of the present invention, a controlling application on an RCD 4 is able to extend its programmatic control to remote UIs 8, such as those on an RUD 5, which interfaces with the IDev 2 (e.g., print/fax driver). In some embodiments, the controlling application on RCD 4 is able to register a remote UI interface 14 with the IDev 2, in a way that is comparable to registering a native UI interface. On the RUD 5/client PC side, the print/fax driver may be a generic driver with a programmatic control interface. In some exemplary embodiments, when the print/fax driver, at the RUD 5, is initiated, the driver may orchestrate the following process:

1. Establish a bi-directional communication with the IDev.

2. The IDev may forward a remote UI description registered by the controlling application/RCD to the print/fax driver on the RUD.

3. The driver/RUD renders the UI as the print/fax settings UI and displays it to a user.

4. The driver/RUD sends the UI responses back to the IDev, which forwards them to the controlling application/RCD.

5. The controlling application/RCD interprets the responses and sends back to the IDev the corresponding actions for the device and/or driver.

The generation of the print data by the print/fax driver may comprise one of the following methods:

1. The driver/RUD waits for the controlling application/RCD to send driver actions. Based on these actions, the driver generates a completed print job.

2. The driver/RUD sends the print data as logical pages (i.e., no sheet assembly, outputting instructions, etc) only when it sends the UI responses to the IDev. The IDev stores the logical pages and waits for the controlling application/RCD to send device actions. Based on these actions, the IDev renders/outputs the logical pages.

The printer/fax driver may be an application/process which converts document data in one format (e.g., MS-Word) into printer ready data (e.g., PCL) and optionally perform (i.e., print emulation) some of the print instructions specified at the UI. In other cases, the printer/driver may be an application which directly manipulates the document data in its original format (i.e., direct print, web browser, URL print, email print, etc.) and optionally perform (i.e., print emulation) some of the print instructions specified at the UI.

### 1. Exemplary Operating Environment

In some embodiments, illustrated with reference to FIG. 2, an exemplary operating environment comprises a network-connected or locally-connected multi-functional peripheral device (IDev) 2 with both walkup and remote job input capabilities. Examples of walkup jobs comprise:

1. Copy

2. Network Scan

3. Hardcopy Fax Out

4. Scan to Storage (e.g., Filing)

5. Media Duplication

6. Print from Filing storage or external media (e.g., USB thumbdrive)

Examples of remote input jobs comprise:

1. Print

2. Scan (e.g., twain driver)

3. PC-Fax

4. Filing

5. Format Conversion

6. Remote Copy

7. Publish to Web

In some embodiments, the IDev 2 may comprise a touch screen UI that can be programmatically controlled by an external (3^{rd} party) controlling application 21, such as may be found on an RCD 4. In some embodiments, the controlling application 21 may be registered on the IDev 2, such as by manual input, programmatic subscription or discovery.

In this mode, the controlling application 21 may send a UI definition 22 to the IDev 2, which the IDev 2 may render as the touch screen 26 UI interface 27 for walkup jobs. When the user enters input to the controlling application's touch screen UI 27, displayed at the IDev 2, the UI input responses may be sent back 23 to the controlling application 21/RCD 4. The controlling application 21/RCD 4 may then interpret the responses and send commands 24, corresponding to the input responses, to the IDev 2 to perform.

The controlling application's bi-directional communication connection 12 with the IDev 2 may be accomplished via many communication transport methods. Exemplary methods comprise:

1. TCP/IP.

2. Apple Talk.

3. IEEE 1284 Parallel Port.

4. IrDA.

5. Bluetooth, Wi-Fi, Wi-MAX, other wireless protocols.

6. Local port: parallel, serial, USB.

### 2. Controlling Application Registration

### Exemplary Embodiment 1—Remote UI Downloaded to IDev

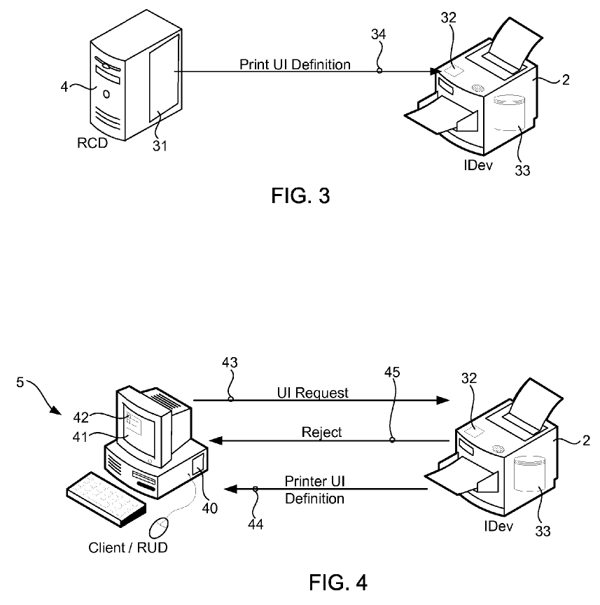

In some embodiments of the present invention, described with reference to FIG. 3, a controlling application 31, running on an RCD 4, may be registered with the IDev 2. This registration process may occur by many methods. Exemplary methods comprise:

1. Manual input through an administrative interface (e.g., key operator code on front panel or embedded web page).

2. Automatic registration by the controlling application/RCD through a programmatic registration interface on the IDev (e.g., Simple Object Access Protocol (SOAP), HTTP, Proprietary protocol over TCP/IP, etc.).

3. Discovery of the controlling application by the IDev by a service discovery protocol (e.g., Service Location Protocol (SLP), Simple Service Discovery Protocol (SSDP), Salutation, WS-Discovery, Microsoft UPnP, Sun Jini, Bluetooth, etc).

As part of the registration, the controlling application 31 on RCD 4 may download 34 the remote UI definition to the IDev 2. The remote UI definition may be in any format suitable for describing a user interface, such as, but not limited to:

1. HTML (Hypertext Markup Language).

2. XML (Extensible Markup Language).

3. XUL (XML-based User Interface Language)—see Mozilla XPToolkit Project.

4. Java Applets.

The IDev 2 may then store the remote UI definition 33 for the registered controlling application 31. An IDev controller 32 may perform IDev file transfer, communication and other functions. Any means of storage may be used, such as, but not limited to:

1. Internal within the device (IDev 4).

2. External to the device, such as on a storage server.

3. Removable storage, such as a USB thumb drive.

In some embodiments, described with reference to FIG. 4, a user may then initiate a remote input job from an RUD/client PC 5 (e.g., desktop PC, laptop, PDA, etc.) using a generic driver 40, which is capable of operating under the programmatic control of a controlling application 31. In these embodiments, the generic driver 40 may establish a bi-directional communication path 43 & 44 with the IDev 2. The communication path may utilize any of many communication media and protocols, such as, but not limited to:

1. SOAP/XML.

2. HTTP.

3. FTP.

4. Proprietary protocol over TCP/IP.

In these embodiments, the generic printer driver 40 may be a driver which converts document data into printer ready data (e.g., Microsoft Windows compatible GDI or XPS printer driver), a direct print application (e.g., Sharp Color DPU), or a web browser (e.g., Microsoft Internet Explorer).

Once the generic driver 40 has established the communication path with the IDev 2, the generic driver 40 may request 43 from the IDev 2 a remote UI interface definition. The IDev 2 may then check if any controlling application with a remote UI is registered with the IDev 2. In some embodiments, the IDev may have more than one controlling application with a remote UI and may make a selection between registered applications based on a best-fit algorithm of by some other method. For example, the controlling application may register itself for either a class of:

1. Users.

2. Scope (e.g., location, departmental association, network domain, etc).

3. Type (e.g., imaging job type: print, fax, file, scan, etc).

If the IDev 2 does not have at least one registered controlling application, the IDev 2 may send a rejection message 45 back to the generic driver 40. If the remote UI request 43 is rejected, the generic driver may either:

1. Terminate the process.

2. Try an alternate device.

3. Use a default User Interface, such as one built into the driver.

The remote UI request 43 from the driver 40 may also be granted/rejected for other reasons, such as:

1. User Authentication—the device may authenticate the user initiating the remote UI request.

2. Host Authentication—the device may be using IP/DNS name filtering to grant or reject access to a group of communication addresses or named devices.

3. Content Authentication—the device may disallow (or only allow) certain types of content to be imaged on the device.

4. Location—the device may disallow (or only allow) access from certain physical locations (e.g., inside the company's building).

If a controlling application is found and/or matched and access granted, the IDev 2 may send a remote UI definition 44 back to the generic driver 40. Generally, the responses 44 and 45 are on the same communication channel as the requests 43, but, in some embodiments, a separate communication channel may be used for back-channel responses 44 & 45.

The generic driver 40 may then render a UI 42 on a display 41 according to the remote UI definition 44 it received. For example, in a Microsoft GDI or XPS print subsystem, a user may initiate a print/fax job by selecting “Print” in an application. The application may respond with a print dialog for selecting an installed printer (e.g., logical printer). The user would then select an installed printer associated with the generic driver. Once selected, the user can select a “Properties” portion on the print dialog, which sends a command to the driver to render the driver specific print setting UI. Thus, in this example, when the user selects the properties button, the generic driver 40 would render the remote UI 42.

Additionally, a generic driver 40 may be directly associated with the IDev 2, such as by a port specification, or a virtual connection which is bound dynamically to the IDev 2, such as by:

1. User input of the IDev's communication address (e.g., IP address) or network domain name (e.g., DNS or WINS).

2. A device discovery method (e.g., WS-Discovery, SNMP discovery, etc).

Additionally, a generic driver 40 may also use programmatic aids in rendering the remote UI 42. For example, if the remote UI definition 44 is in an XML format, the generic driver 40 may use an XML style sheet (XSLT) to define how to render the XML data into a visual representation. Exemplary rendering aids may comprise:

1. The controlling application.

2. The IDev.

3. The driver.

In some embodiments, a user may be submitting an imaging job using a direct submit (i.e., driver-less) application. In these cases, the direct submit application may perform the same remote UI functions as described for the generic driver 40.

In some embodiments, a user may submit an imaging job using a web browser. In these cases, the web browser may perform the same remote UI functions as described for the generic driver 40.

In some embodiments, a user may submit an imaging job using an email application. In these cases, the email application may perform the same remote UI functions as described for the generic driver 40.

### 3. Controlling Application Registration

### Embodiment 2—Remote UI Registered with IDev

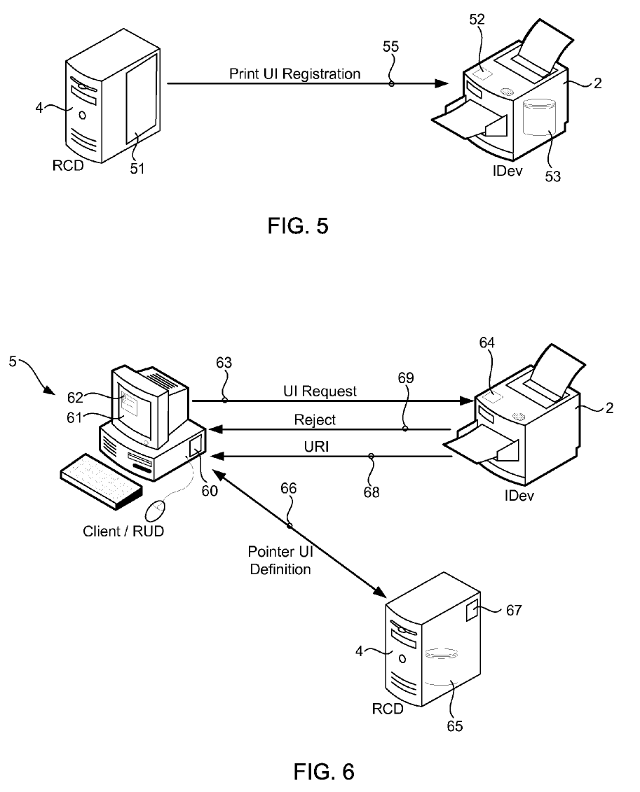

In some embodiments, described with reference to FIG. 5, a controlling application 51 may be registered with an IDev 2, such as by methods described above.

In these embodiments, the registration process differs from the above in that the controlling application 51 does not download the remote UI definition to the IDev 2. Instead, the remote UI definition remains resident with the controlling application. As part of the registration process, the registration may comprise:

1. A URI or URL identifying the location of the remote UI definition.

2. A programmatic interface call to the controlling application to request the controlling application to download the remote UI definition.

In some embodiments, described with reference to FIG. 6, a user may initiate a remote input job from a client PC/RUD 5 (e.g., desktop PC, laptop, PDA, smart phone, etc) using a generic driver 60, which is capable of operating under the programmatic control of a controlling application 67. In these embodiments, the generic driver 60 may establish a bi-directional communication path 63 & 69 with an IDev 2, using any method such as those described above.

Once the generic driver 60 has established the communication path 63 & 69 with the IDev 2, the generic driver 60 may request 63 from the IDev 2 a remote UI interface definition. The IDev 2 may then check if any controlling application with a remote UI is registered with the IDev 2. In some embodiments, the IDev 2 may have more than one controlling application with a remote UI and may make a selection as describe above or by other methods.

If the IDev 2 does not have at least one registered controlling application, the IDev 2 may send a rejection message 69 back to the generic driver 60. If the remote UI request 63 is rejected, the generic driver 60 may respond as described above in relation to embodiments illustrated in FIG. 4.

If a controlling application 67 is found and/or matched and access is granted, the IDev 2 may send a remote UI URI 68 (or programmatic call) back to the generic driver 60. If the response is in the form of a URI, the generic driver 60 may directly pull 66 the remote UI definition from the controlling application's UI storage 65, which may be remote or local to the RCD 4. In other embodiments, a programmatic call 68, sent to the generic driver 60 may establish a communication channel 66 with the controlling application 67 over which a remote UI definition (based on the programmatic call) may be requested. The controlling application 67 may then respond by transmitting the remote UI definition to the generic driver 60. Many protocols and data formats may be used for communications and remote UI definitions such as those described earlier in relation to other embodiments.

In other embodiments, a user may be submitting an imaging job using a direct submit (i.e., driverless) application. In these embodiments, the direct submit application may perform the same remote UI functions as described for the generic driver above.

In other embodiments, a user may be submitting an imaging job using a web browser. In these embodiments, the web browser application may perform the same remote UI functions as described for the generic driver above.

In other embodiments, a user may be submitting an imaging job using an email application. In these embodiments, the email application may perform the same remote UI functions as described for the generic driver above.

### 4. Controlling Application Registration

### Embodiment 3—RUD URI Passed to IDev

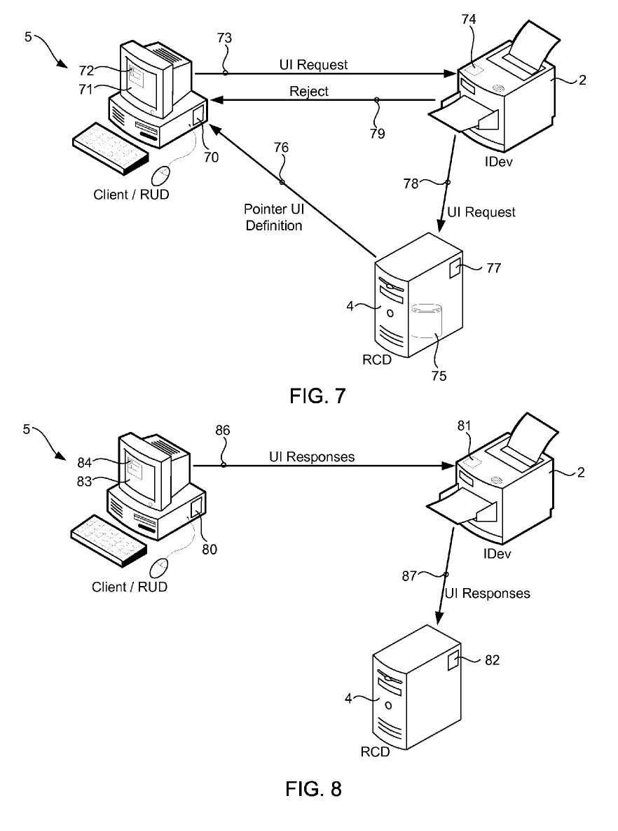

In some embodiments, described with reference to FIG. 7, a user may initiate a remote input job from a client PC/RUD 5 (e.g., desktop PC, laptop, PDA, etc) using a generic driver 70, which is capable of operating under the programmatic control of a controlling application 77. In these embodiments, the generic driver 70 may establish a bi-directional communication path 73 & 79 with an IDev 2, using any method such as those described above.

Once the generic driver 70 has established the communication path 73 & 79 with the IDev 2, the generic driver 70 may request 73 from the IDev 2 a remote UI interface definition. The IDev 2 may then check if any controlling application with a remote UI is registered with the IDev 2. In some embodiments, the IDev 2 may have more than one controlling application with a remote UI and may make a selection as describe above or by other methods.

If the IDev 2 does not have at least one registered controlling application, the IDev 2 may send a rejection message 79 back to the generic driver 70. If the remote UI request 73 is rejected, the generic driver 70 may respond as described above in relation to embodiments illustrated in FIG. 4.

If a controlling application 77 is found and/or matched and access is granted, the IDev 2 may send a remote UI URI, programmatic call or another message 78 to the controlling application 77 requesting that the UI definition be sent to the generic driver 70. The controlling application 77 may then send 76 a UI definition 75 directly to the generic driver 70 identified in the message 78. The UI definition may be read from the controlling application's UI storage 65, which may be remote or local to the RCD 4. Many protocols and data formats may be used for communications and remote UI definitions such as those described earlier in relation to other embodiments.

In other embodiments, a user may be submitting an imaging job using a direct submit (i.e., driverless) application. In these embodiments, the direct submit application may perform the same remote UI functions as described for the generic driver above.

In other embodiments, a user may be submitting an imaging job using a web browser. In these embodiments, the web browser may perform the same remote UI functions as described for the generic driver above.

### 5. Remote Job Input

### Embodiment 1—Client/RUD Interfaces with Controlling Application Via IDev

In some embodiments, described with reference to FIG. 8, a user may enter a selection (e.g., cursor, mouse selection, text input) into a generic driver's rendered remote UI 83. The input responses 85 may then be recorded by the generic driver 80. The input responses 85 may be associated with a specific selection control element (e.g., button selection, input box), a grid coordinate that can be mapped back to a selection control element or by some other association method. Exemplary input responses may comprise:

1. Click of a button or checkbox selected/deselected.

2. Index of an element within an enumerated selection list.

3. Text entered into input box.

The input responses may then be sent 86 back to the IDev 2. The input responses 86 may be sent over the same communication channel used for a remote UI request from the IDev 2, or another (e.g., asynchronous) communication channel specifically for inputting a remote job.

The IDev 2 may then forward 87 the input responses to the controlling application 82. In some embodiments, the format of the input responses 86 between the RUD 5 and IDev 2 may be different than the format of the responses 87 between the IDev 2 and controlling application 82. In such a case, the IDev 2 may translate the input responses into a format compatible with the controlling application 82. The IDev 2 may use many methods to establish a communication path and forward the input responses to the controlling application, such as by using a SOAP/XML web service.

Additionally, the input responses 86 between the RUD/client 5 and IDev 2 and/or the responses 87 between the IDev 2 and controlling application 82 may be encrypted and/or compressed.

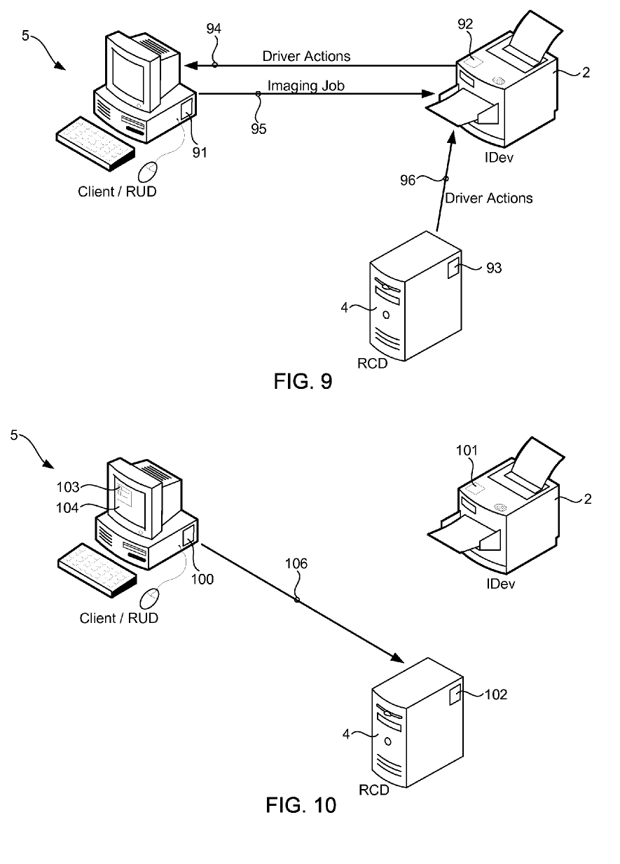

Some embodiments of the present invention may be described with reference to FIG. 9. In these embodiments, upon receipt of responses, the controlling application 93 interprets the responses. Based on the input data and associated control, the responses are converted into driver actions 96, specific to the generic driver 91. For example, printer drivers in the MS GDI print subsystem use a DEVMODE data structure to specify print settings. In this exemplary embodiment, the controlling application 93 may convert the responses (e.g., print settings) into the corresponding binary settings in a DEVMODE structure compatible with the generic driver 91.

In some embodiments, the controlling application 93 may convert the responses into a common job setting language compatible with the generic driver 91, such as representing the actions in an XML format (e.g., such as Microsoft's XPS definition for a Print Ticket).

In some embodiments, the controlling application may send the driver actions to the IDev 2. In some embodiments, the IDev controller 92 will receive the actions. The controlling application 93 may use the same communication channel by which the IDev 2 sends input responses to the controlling application 93, or another communication channel.

The IDev 2 may then forward the driver actions 94 to the generic driver 91. In some embodiments, the data format of the driver actions 94 between the IDev 2 and generic driver 91 is the same as the format of the driver actions 96 sent between the controlling application 93 and the IDev 2, and they may be forwarded without modification. In some embodiments, the formats may be different, and the IDev 2 may translate the driver actions 96 from the controlling application 93 into a format compatible with the generic driver 91. The IDev 2 may use any communication channel to send the driver actions back to the generic driver 91, such as the same communication channel used to receive the remote UI responses from the generic driver, or another communication channel.

The generic driver 91 may interpret the driver actions 94 received from the IDev 2 into print settings, and may perform the associated operations to produce an imaging job 95 which is compatible with the IDev 2 and which reflects the user's input intentions. The imaging job 95 is then sent by the generic driver 91 to the IDev 2 for rendering/outputting. The imaging job 95 may be sent by any communication channel, such as the communication channel used to receive the driver actions from the IDev 2, or another communication channel (e.g., a legacy printing port such as LPR, RAW 9100).

In some embodiments, a user may be submitting an imaging job using a direct submit (i.e., driverless) application. In these cases, the direct submit application may perform the same remote UI functions as described for the generic driver 91.

In some embodiments, a user may be submitting an imaging job using a web browser. In these cases, the web browser may perform the same remote UI functions as described for the generic driver 91.

In some embodiments, a user may be submitting an imaging job using an email application. In these cases, the email application may perform the same remote UI functions as described for the generic driver 91.

### 6. Remote Job Input

### Embodiment 2—Client Interfaces Directly with Controlling Application

In some embodiments of the present invention, a user may enter selections into a generic driver's rendered remote UI 103 on a touch-screen display 104 or some other UI. The input responses 106 are then recorded by the generic driver 100. The input responses 105 may be associated with a specific selection control element, a grid coordinate that can be mapped back to a selection control element or they may be associated by some other relationship.

The input responses 106 may then be sent directly to the controlling application 102. The input responses 106 may be sent by any communication channel and data protocol. For example, if the generic driver 100 received a remote UI definition directly from a controlling application 102, the generic driver 100 may use the same communication channel. Otherwise, the generic driver 100 may establish another communication channel, such as over TCP/IP to transmit the data, such as a SOAP/XML message.

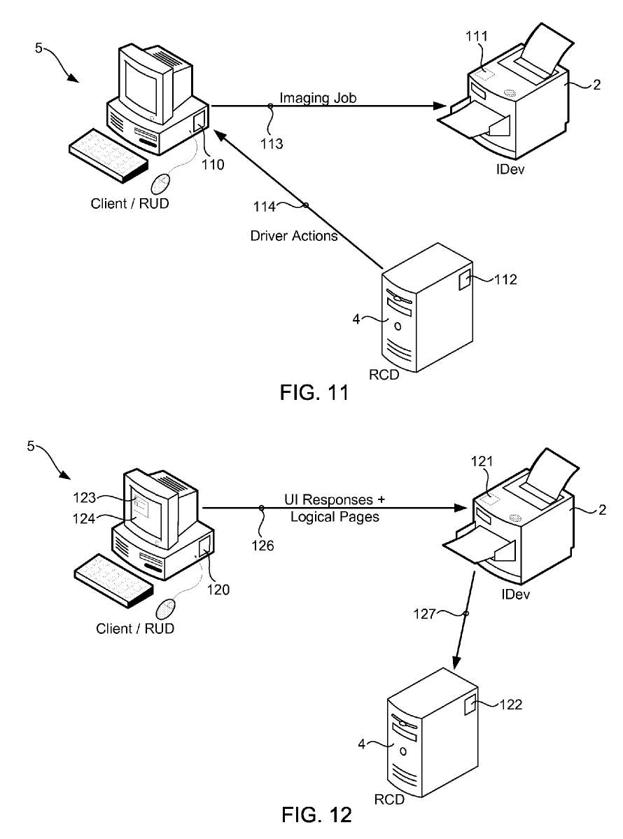

In some embodiments, the input responses between the client/RUD 5 and the controlling application 102 may be encrypted and/or compressed. Some embodiments of the present invention may be described with reference to FIG. 11. In these embodiments, the controlling application 112 may interpret received responses based on input data and associated control functions. The interpreted responses may then be converted into driver actions 114, specific to the generic driver 110, such as in the methods described earlier.

In some embodiments, the controlling application 112 may convert received actions into a common job setting language compatible with the generic driver 110, such as representing the actions in an XML format (e.g., such as Microsoft's XPS definition for a Print Ticket).

A controlling application 112 may send driver actions 114 to the generic driver 110. The controlling application 112 may use the same communication channel by which the generic driver 112 sent input responses, or another communication channel.

The generic driver 110 may then interpret the driver actions 114 received from the controlling application 112 into print settings and perform the associated operations to produce an imaging job 113 which is compatible with the IDev 2 and which reflects the user's input intention. The imaging job 113 may then be sent by the generic driver 110 to the IDev 2 for rendering/outputting. The imaging job may be sent by any communication channel, such as using a SOAP/XML web service or a legacy printing port (e.g., LPR, RAW 9100).

In other embodiments (including, for example, web browser generated print jobs and email generated print jobs), a user may be submitting an imaging job using a direct submit (i.e., driverless) application. In these cases, the direct submit application may perform the same remote UI functions as described for the generic driver 110.

### 7. Remote Job Input

### Embodiment 3—Client Interfaces with Controlling Application Via IDev 2

In some embodiments of the present invention, described with reference to FIG. 12, a user may enter selections into a generic driver's rendered remote UI 123. The input responses may then be recorded by the generic driver 120. The input responses may be associated with a specific selection control element, a grid coordinate that can be mapped back to a selection control element or they may be associated by some other relationship.

In some embodiments, the generic driver 120 may convert the document data into a print (or fax or file) format compatible with the IDev 2 as logical pages (i.e., not formatted for sheet placement, sheet assembly and outputting).

The input responses and logical pages 126 may then be sent back to the IDev 2. The input responses/logical pages 126 may be sent over the same communication channel that was used for a remote UI request from the IDev 2, or another (e.g., asynchronous) communication channel specifically for inputting a remote job.

In some embodiments, the IDev 2 may store the logical pages and then forward the input responses 127 to the controlling application 122. In some embodiments, the format of the input responses 126 between the client/RUD 5 and the IDev 2 may be different than the format of the UI responses 127 between the IDev 2 and controlling application 122. In such a case, the IDev 2 may translate the input responses 126 into a format compatible with the controlling application 122. The IDev 2 may use any method to establish a communication path and forward the input responses to the controlling application, such as by using a SOAP/XML web service.

In some embodiments, the input responses between the client/RUD 5 and the IDev 2 and/or between the IDev 2 and the controlling application 122 may be encrypted and/or compressed.

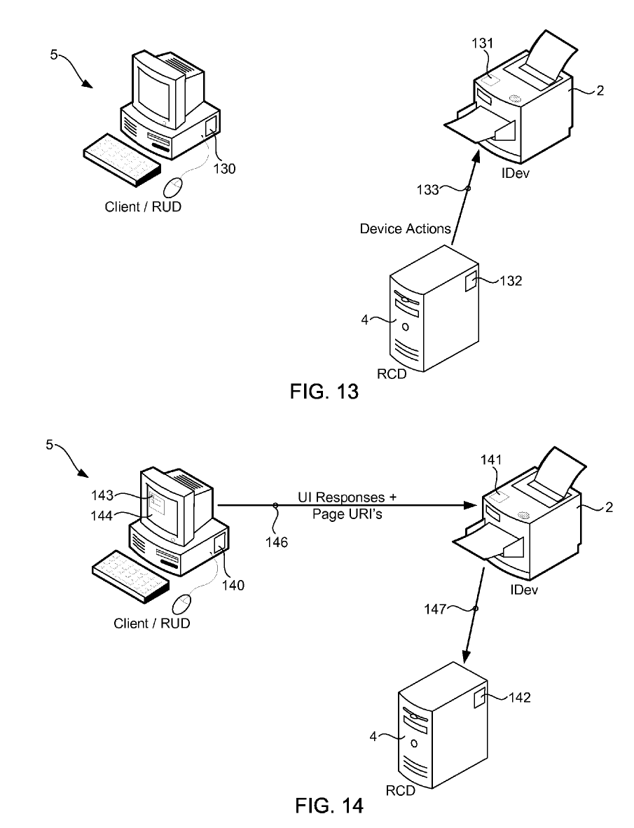

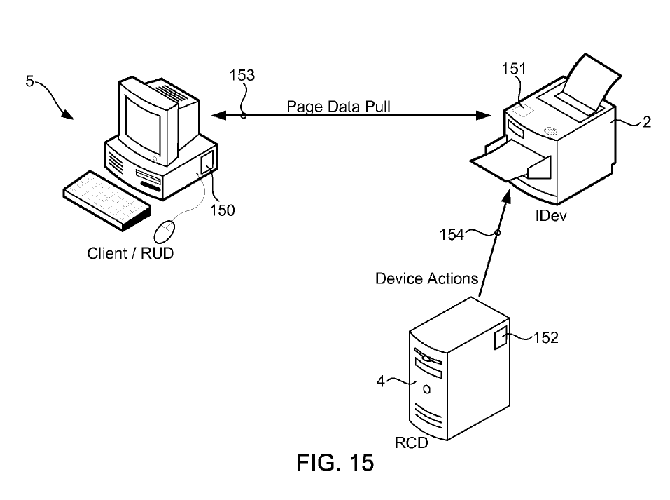

In some embodiments of the present invention, described with reference to FIG. 13, a controlling application 132 may interpret received responses based on input data and associated control functions. The interpreted responses may then be converted into device actions 133, specific to the IDev 2. For example, HP PJL/PCL compatible printers accept print settings in a PJL (Printer Job Language) format. In this example, the controlling application 132 converts the responses (e.g., print settings) into the corresponding PJL commands compatible with the IDev 2.

In some embodiments, the controlling application 132 may convert actions into a common job setting language compatible with the IDev 2, such as by representing the actions in an XML format (e.g., such as Microsoft's XPS definition for a Print Ticket).

A controlling application may send device actions 133 to the IDev controller 131 in the IDev 2. The controlling application 132 may use the same communication channel by which the IDev 2 sends input responses, or another communication channel.

The IDev 2 may then retrieve the logical pages and interpret the device actions 133 received from the controlling application 132 into print settings. The IDev 2 may also perform the associated operations to render/output the imaging job.

In other embodiments (including, for example, web browser generated print jobs and email generated print jobs), a user may be submitting an imaging job using a direct submit (i.e., driverless) application. In these cases, the direct submit application may perform the same remote UI functions as described for the generic driver 130.

### 8. Remote Job Input

### Embodiment 4—Client Interfaces Directly with Controlling Application

In some embodiments of the present invention, described with reference to FIG. 14, a user may enter a selection into a generic driver's rendered remote UI 143. The input responses 145 may then be recorded by the generic driver 140. The input responses may be associated with a specific selection control element, a grid coordinate which can be mapped back to a selection control element or they may be associated by some other relationship. In some embodiments, the generic driver 140 may convert the document data into a print (or fax or file) format compatible with the IDev 2 as logical pages (i.e., not formatted for sheet placement, sheet assembly and outputting). The logical pages may then be retained by the generic driver 140.

In some embodiments, input responses and URIs (Uniform Resource Indicators) 146 to the logical pages may be sent to the IDev 2. The input responses/Page URIs 146 may be sent over the same communication channel that was used for a remote UI request from the IDev 2, or another (e.g., asynchronous) communication channel specifically for inputting a remote job.

The IDev 2 may store the Page URIs and forward the input responses 147 to the controlling application 142. In some embodiments, the format of the input responses between the client/RUD 5 and IDev 2 may be different than between the IDev 2 and controlling application 142. In such a case, the IDev 2 may translate the input responses 146 into a format compatible with the controlling application 142. The IDev 2 may use any method to establish a communication path and forward the input responses 147 to the controlling application, such as by using a SOAP/XML web service.

In some embodiments of the present invention, a controlling application 142 may interpret responses received at a UI, based on the input data and associated control functions. The interpreted responses may then be converted into device actions, specific to the IDev 2, as described in relation to other embodiments above.

In some embodiments, a controlling application 152 may convert the actions into a common job setting language compatible with the IDev 2, such as by representing the actions in an XML format (e.g., such as Microsoft's XPS definition for a Print Ticket).

The controlling application 152 may then send the device actions 154 to an IDev 2. The controlling application may use the same communication channel by which the IDev 2 sent input responses, or another communication channel.

The IDev 2 may then pull or request 153 any associated logical pages from the generic driver 150, using the page URIs and interpret the device actions received from the controlling application into print settings. The IDev 2 may also perform the associated operations to render/output the imaging job.

In some embodiments, a user may be submitting an imaging job using a direct submit (i.e., driverless) application. In these cases, the direct submit application may perform the same remote UI functions as described for the generic driver 150.

In some embodiments, a user may be submitting an imaging job using a web browser. In these cases, the web browser may perform the same remote UI functions as described for the generic driver 150.

In some embodiments, a user may be submitting an imaging job using an email application. In these cases, the email application may perform the same remote UI functions as described for the generic driver 150.

While many embodiments described above were written in the context of an exemplary print job, other embodiments may comprise other remote input imaging operations which render an output in either soft or hardcopy format, such as fax, scan, file, publish, display, media duplication and format conversion.

### 9. Administrative Procedures using the Remote User Interface

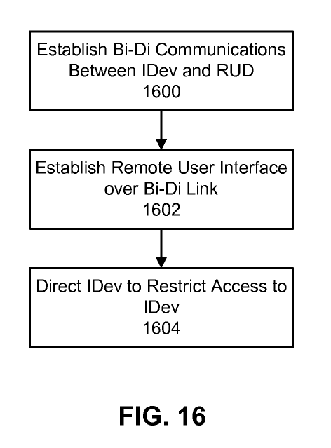

In addition to the above methods and structures for initially creating a remote user interface between an IDev and an associated other system (i.e., an RUD or any remote user interface application), various other administrative functions and processing may be enabled to utilize a remote user interface as discussed above. FIGS. 16 through 21 discussed below present still further enhancements to allow administrative tasks and processes to utilize a remote user interface as described above.

In some embodiments as described in FIG. 16, a remote user interface may be utilized to restrict access to an IDev such that only particular identified remote user devices may interact with the IDev while other processes may be restricted or precluded from such access to the IDev. Step 1600 of FIG. 16 first establishes a bi-directional communication link between the IDev and a remote user device (RUD). Step 1602 then establishes a remote user interface (as discussed above) over the bi-directional communication link (as discussed above). Utilizing the established remote user interface, steps 1604 may then direct the IDev to restrict access permitted to the IDev by other users or processes.

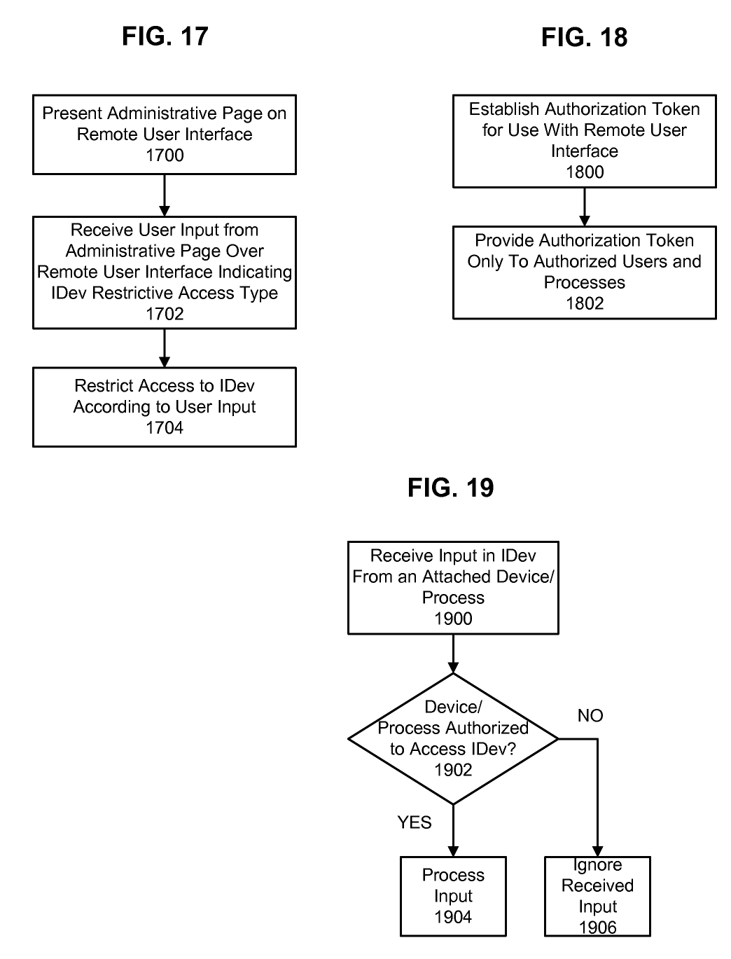

FIGS. 17 through 19 provide exemplar additional details of the generalized method of FIG. 16. FIG. 17 represents exemplary additional processing associated with the restrictive access described above in FIG. 16. Step 1700 first presents an administrative page to an administrative user using the remote user interface. Among other things, the administrative page presented provides an option for an administrative user to indicate that the access to the corresponding IDev should be restricted in one of various manners. Step 1702 then receives user input from the administrative page over the remote user interface. The received user input indicates the type of restriction desired for access to the IDev. Step 1704 then implements the requested restricted access to the IDev based on the user's input. By way of example, the user's input in response to the administrative page prompting may indicate that no restrictions should be imposed such that any device, process, or user may access the associated IDev. Such an option may be used to remove previously added restrictions. Further, by way of example, restrictions may be specified by an administrative user such that the IDev may be accessed without restriction by a user of the user interface (e.g., “front panel”) integral with the IDev (i.e., no restriction for “walkup” access). However, network access by remote user devices (other than the RUD which has provided the remote user interface) is restricted. Still further, by way of example, the user input may specify that the IDev may be accessed only by remote user devices that utilize a remote user interface (i.e., precluding access by the integral front panel for “walkup” IDev interaction). These and other exemplary forms of restriction may be specified by the administrator page provided by step 1702 and by user input received therefrom.

In other embodiments, restricted access may be controlled by establishing an authorization token for use in conjunction with the remote user interface or any other user interface to the IDev. The authorization token may be any suitable key, password, UID, biometric information, etc. such that any user of the integral front panel (i.e., “walkup” user) or any remote user interface user/process must provide the specified authorization token to be permitted access to the corresponding IDev. In FIG. 18, step 1800 establishes or generates such an authorization token for use with the remote user interface (or any other user interface associated with the IDev). Step 1802 then provides the authorization token only to authorized users or processes associated with the IDev (e.g., provided only to processes using a remote user interface on an authorized RUD or physically provided to users for authorized “walkup” access).

FIG. 19 is a corresponding flowchart representing processing of the IDev associated with the established restricted access. Step 1900 represents processing of the IDev to receive any input from any attached device, process, or user. Step 1902 determines whether the received input has been authorized to access the IDev. If so, step 1904 represents any normal processing within the IDev to process the received input from the device or process that has been authorized to access the IDev. If not, step 1906 represents processing within the IDev to simply ignore input received from a process or device that does not have access granted to the IDev.

As noted above, determination of authorization to access the IDev may be by means of the authorization token established as discussed above in FIG. 18 and provided to only those users or processes that are intended to have access to the IDev. Still further, access may be determined simply by an identity of the user or process attempting to access the IDev and corresponding tabular information stored within the IDev describing those users or processes which are allowed to access the IDev.

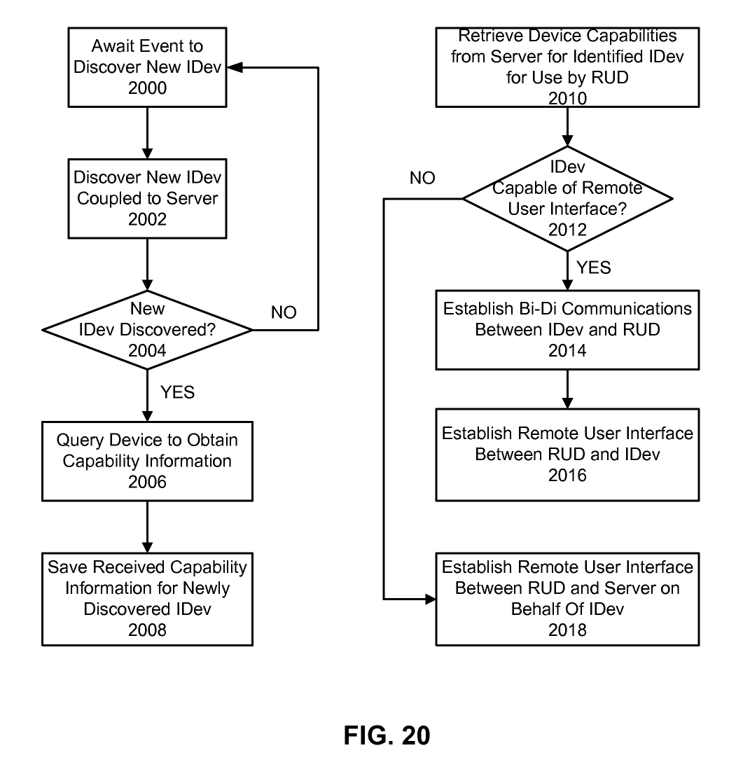

FIG. 20 is a flowchart describing yet another exemplary administrative process that may be carried out by use of the remote user interface discussed above. The method of FIG. 20 generally describes a technique whereby an IDev coupled to the server in a system may be initially discovered by the server and capabilities and features associated with a newly discovered IDev may be cached within the server for use by other remote user devices desiring access to the newly discovered IDev. Each RUD may access the newly discovered IDev utilizing remote user interface features as discussed above if such features are enabled in the newly discovered IDev capabilities. In the alternative, where the newly discovered IDev is incapable of permitting remote user interface features, the server may emulate such a capability on behalf of the IDev so that all RUDs may presume access to an IDev utilizing a remote user interface regardless of whether the IDev directly supports the remote user interface or whether the server emulates such remote user interface capabilities.

Step 2000 awaits any appropriate event to cause discovery of a new IDev. Exemplary events that may cause the performance of the discovery process may include any or all of: an administrative user manually requesting such discovery processing, automated periodic performance of the discovery process, an administrative user requesting such discovery processing via a remote user interface application, or a discovery process initiated in response to events detected from devices coupled to a common network (e.g., automatically sensing the presence of some new device on a common network and attempting to discover information about the newly sensed device). Upon occurrence of such an event, step 2002 attempts to discover whether a previously unknown IDev is now sensed as present on some associated network coupled with the server performing the discovery process. Step 2004 determines whether any such new IDev was discovered. If not, this particular event is ignored and processing awaits the next sensed event looping back to step 2000.

If step 2004 determines that a new IDev is covered, step 2006 next queries the newly discovered device to obtain capability information regarding the newly discovered device. The capability information may include, for example, imaging capabilities and processing features associated with a device. The capability information may further include information regarding remote user interface capabilities of the newly discovered IDev. For example, the capabilities may indicate simply that the newly discovered IDev does not allow for remote user interface or may indicate specific user interface information accessible through a remote user interface as discussed above. Where the newly discovered IDev it as a printing device, the capabilities information may specifically include printer capabilities and print ticket specifications for access to the newly discovered printer IDev. Step 2008 saves the retrieved capability information in the server such that any printer driver or remote user device may obtain the capability information directly from the server. The server thus represents a central repository for capability information for a plurality of IDevs. Still further, since the server collecting the capability information is aware of which IDevs are capable of directly supporting remote user interfaces, the server may also provide emulation capabilities to allow any RUD to access an IDev using a remote user interface. The remote user interface features may be provided by the server as an emulator where the IDev is incapable of directly supporting remote user interface capabilities.

Eventually, when a remote user interface application operable on a remote user device (RUD) desires access to an identified IDev, step 2010 represents processing by the RUD to retrieve device capability information from the server for a particular identified IDev. Step 212 then determines whether the capability information indicates that the identified IDev is capable of supporting remote user interface features. If not, step 2018 establishes a remote user interface between the requesting RUD and the server on behalf of the IDev. In other words, step 2018 represents emulation of a remote user interface on behalf of an identified IDev for use by a requesting RUD to access the IDev.

If step 2012 determines that the identified IDev is capable directly supporting remote user interface features as defined by its capability information, step 2014 next establishes a bi-directional communication link directly between the identified IDev and the requesting RUD. Step 2016 establishes the remote user interface capability directly between the requesting RUD and the identified IDev.

In accordance with the embodiments described in FIG. 20, the server maintains a central repository for storing capability information allowing the centralized server to coordinate establishment of remote user interface between newly discovered IDevs and requesting RUDs. By receiving and storing capability information regarding each IDev, the central server may provide emulation capability for remote user interfaces associated with IDevs that do not directly support such remote user interface capabilities.

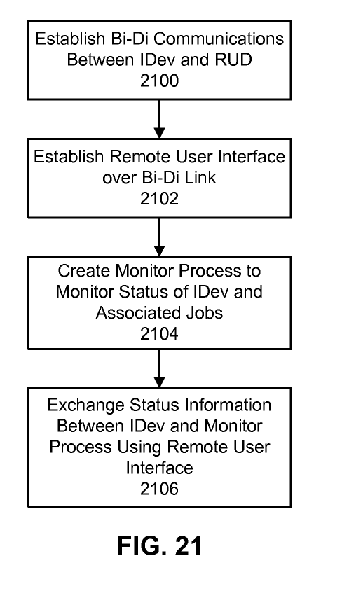

FIG. 21 describes yet another administrative procedure that may be provided based on the remote user interface features described above. In some embodiments, a monitor process may be created or spawned to allow continuous monitoring of job status or device status corresponding to a particular IDev. A remote user interface application operable, for example, on a remote user device (RUD) may spawn a background process that continues to operate—monitoring progress of particular jobs, monitoring the overall status of the identified IDev, or controlling performance of particular jobs queued for execution of the identified IDev.

Step 2100 first establishes a bi-directional communication link between an identified IDev and a remote user device (RUD). In particular, the device driver of the RUD may be engaged to establish the bi-directional communication with the identified IDev. Step 2102 then establish a remote user interface using the bi-directional communication link between the RUD and the identified IDev. Step 2104 then creates or spawns a monitor process to monitor the status of the device and/or to monitor associated jobs on the identified IDev. Step 2106 represents ongoing processing of the monitor process to exchange status information between the identified IDev and the monitor process utilizing the remote user interface capabilities.

The exchanged information may include, for example, general status information regarding all jobs presently known to the identified IDev, operational status of the identified IDev, and any other appropriate status information regarding operational status of the IDev and/or jobs associated with the IDev. In addition, the information exchanged may include control related information relating to control of particular identified jobs in the identified IDev. For example, control information may include requests to commence or cancel execution of an identified job in the identified IDev. Further, for example, control information may include requests to suspend or resume processing of an identified job in the identified IDev. Further, for example, control information may include requests to alter the processing of an identified job in the identified IDev.

The status information exchange may be presented to a user on the remote user interface. Further, control information relating to particular identified jobs on the identified IDev may be determined in accordance with user input received from the remote user interface.

Embodiments of the present invention may comprise elements of the print subsystems of the Microsoft Windows operating system, Apple MacIntosh Operating System, Linux Operating System, System V Unix Operating Systems, BSD Unix Operating Systems, OSF Unix Operating Systems, IBM Mainframe MVS Operating System, and IBM AS/400.

The terms and expressions which have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims which follow. While the invention has been illustrated and described in the drawings and foregoing description, such illustration and description is to be considered as exemplary and not restrictive in character. Various embodiments of the invention and minor variants thereof have been shown and described. In particular, those of ordinary skill in the art will readily recognize that exemplary methods discussed above may be implemented as suitably programmed instructions executed by a general or special purpose programmable processor or may be implemented as equivalent custom logic circuits including combinatorial and/or sequential logic elements. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. A method for performing administrative controls on an imaging device, the method comprising:
establishing a bi-directional communication link between an imaging device (IDev) and a remote user device (RUD);
establishing a remote user interface over the bi-directional communication link wherein the remote user interface is used by a user of the IDev to control a remote application operable on the RUD and/or is used by a user of the RUD to control the IDev; and
directing the IDev to restrict access to the IDev responsive to the establishment of the remote user interface.

2. The method of claim 1 further comprising:
presenting an administrative page on the remote user interface wherein the administrative page includes an option indicating a desire to restrict access to the IDev; and
receiving user input from the administrative page indicating a user's desire to restrict access to the IDev,
wherein the step of directing is responsive to a user indicating the desire to restrict access to the IDev.

3. The method of claim 2
wherein the step of receiving further comprises:
receiving user input indicating the desire to restrict access to the IDev to only the RUD,
wherein the step of directing further comprises:
directing the RUD to reject any access by any device other than the RUD.

4. The method of claim 2
wherein the step of receiving further comprises:
receiving user input indicating the desire to allow access to the IDev by any remote user device but to restrict access by a user interface integral with the IDev,
wherein the step of directing further comprises:
directing the RUD to reject any access to the IDev by a user of the user interface integral with the IDev.

5. The method of claim 1 further comprising:
establishing an authorization token in the IDev where the token is provided only to devices allowed access to the IDev.

6. The method of claim 5
wherein the step of directing further comprises:
directing the IDev to accept input from any device that provides the authorization token to the IDev; and
directing the IDev to ignore input from any device that does not provide the authorization token to the IDev.

7. A method for performing administrative controls on an imaging device, the method comprising:
discovering an imaging device (IDev) coupled to a server system;
querying the imaging device to determine capability information relating to features supported by the imaging device;
saving the capability information in the server;
retrieving the capability information from the server for use by a remote user device (RUD);
establishing a remote user interface based on the retrieved capability information, the remote user interface used by a user of the RUD to control the IDev.

8. The method of claim 7
wherein the IDev is a printer, and
wherein the capability information includes print capabilities of the printer and print ticket specifications of the printer.

9. The method of claim 7 further comprising:
establishing a bi-directional communication link between the imaging device (IDev) and the RUD,
wherein the remote user interface is established over the bi-directional communication link.

10. The method of claim 7 further comprising:
establishing a bi-directional communication link between the server and the RUD,
wherein the remote user interface is established over the bi-directional communication link.

11. The method of claim 7
wherein the method is performed responsive to receipt of user input requesting discovery of a new IDev.

12. The method of claim 7
wherein the method is performed periodically.

13. The method of claim 7
wherein the method is performed responsive to installation of a new remote user interface application that requires use of the remote user interface.

14. A method for performing administrative controls on an imaging device, the method comprising:
establishing a bi-directional communication link between an imaging device (IDev) and a remote user device (RUD);
establishing a remote user interface over the bi-directional communication link wherein the remote user interface is used by a user of the IDev to control a remote application operable on the RUD and/or is used by a user of the RUD to control the IDev;
creating a monitor process on the RUD to monitor status of the IDev; and
exchanging status information between the monitor process and the IDev using the remote user interface to report status of the IDev to a user of the remote user interface.

15. The method of claim 14
wherein the step of exchanging further comprises:
receiving status information regarding a job within the IDev,
the method further comprising:
presenting status of the job to a user of the remote user interface.

16. The method of claim 14
wherein the step of exchanging further comprises:
receiving user input through the remote user interface regarding processing of a job by the IDev,
the method further comprising:
modifying the processing of the job responsive to the received user input.

17. The method of claim 16
wherein the step of modifying further comprises one or more of: commencing processing of the job, cancelling processing of the job, suspending processing of the job, and resuming processing of the job.
